(19) United States
(12) Patent Application Publication
(10) Pub. No.: US 2014/0325285 A1
(43) Pub. Date: Oct. 30, 2014

(54) SERIAL ATTACHED SCSI EXPANDER AND METHOD FOR DEBUGGING FAULTS THEREOF

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/264,060

(22) Filed: Apr. 29, 2014

(30) Foreign Application Priority Data
Apr. 29, 2013 (TW) 102115241

(51) Int. Cl. G06F 11/07

(52) U.S. Cl. CPC G06F 11/0745
USPC 714/43

(57) ABSTRACT

Serial Attached SCSI (SAS) expander includes an exposed SAS interface connector, a microcontroller unit (MCU), a smart port, and an SAS expander chip. The SAS interface connector is coupled to a host personal computer (PC) to receive commands sent from the host PC. When a fault occurs in the SAS expander or a connected storage device, the MCU enables the smart port in response to a first control command sent from the host PC, reads status information from the SAS expander chip through the smart port in response to a status reading command sent from the host PC, and sends read status information back to the host PC for analyzing. MCU obtains detailed fault information from the SAS expander chip through the smart port in response to a detailed fault information obtaining command sent from the host PC and sends the obtained detailed fault information back to the host PC.

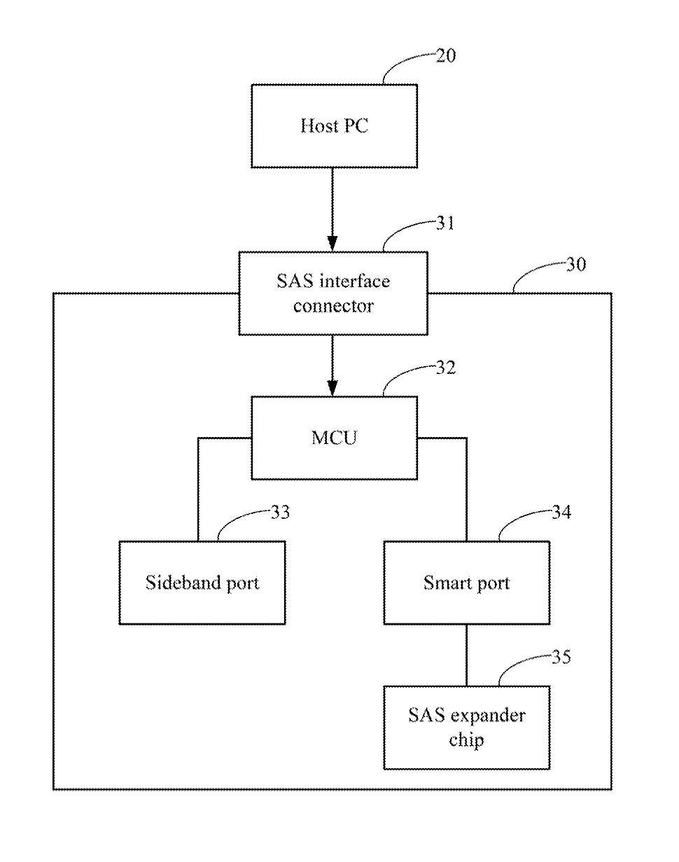

### FIELD

The present disclosure relates to a Serial Attached SCSI (SAS) expander and a method for debugging faults of the SAS expander.

### BACKGROUND

SAS is a point-to-point serial protocol that moves data to and from computer storage devices such as hard drives and tape drives. SAS expanders are used to connect computer storage devices together. Most existing SAS expanders are provided with closed structures, and are connected to other SAS expanders or storage devices via an exposed SFF-8087 or SFF-8088 interface connector.

### BRIEF DESCRIPTION OF THE DRAWINGS

Many aspects of the embodiments described herein can be better understood with reference to the following drawing. The components in the drawing are not necessarily drawn to scale, the emphasis instead being placed upon clearly illustrating the principles of the present disclosure.

The FIGURE is a block diagram of one embodiment of an SAS expander.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

The figure illustrates a block diagram of one embodiment of an SAS expander 30. The SAS expander 30 can connect a number of storage devices (not shown) together. In at least one embodiment, the SAS expander 30 includes an exposed SAS interface connector 31. The SAS expander 30 is coupled to a host personal computer (PC) 20 via the exposed SAS interface connector 31. In the embodiment, the SAS interface connector 31 can be an SFF-8087 interface connector or an SFF-8088 interface connector.

In the embodiment, the SAS expander 30 further includes a microcontroller unit (MCU) 32, a sideband port 33, a smart port 34, and an SAS expander chip 35 arranged in the internal of the SAS expander 30. The MCU 32 is connected to the SAS interface connector 31, the sideband port 33, and the smart port 34. The smart port 34 is connected to the SAS expander chip 35. In the embodiment, the smart port 34 is a debug port.

In the embodiment, the host PC 20 can send commands to the SAS expander 30 through the SAS interface connector 31, to control the MCU 32 to enable the sideband port 33 or the smart port 34.

In the embodiment, under a normal condition, the MCU 32 enables the sideband port 33, and controls the sideband port 33 to perform data transmission functions, such as transmitting data information to and from the storage devices connected to the SAS expander 30.

When a fault occurs in the SAS expander 30 or one of the connected storage devices, the host PC 20 can send commands to the MCU 32 to debug the fault through the smart port 34.

In the embodiment, the MCU 32 enables the smart port 34 in response to a first control command sent from the host PC 20. The MCU 32 further reads status information from the SAS expander chip 35 through the smart port 34 after receiving a status reading command sent from the host PC 20, and sends the read status information back to the host PC 20 for analyzing. Maintenance personnel can determine an origin of the fault by analyzing the status information received by the host PC 20, and can use the host PC 20 to send a detailed fault information obtaining command to the MCU 32, in order to obtain detailed fault information for debugging.

The MCU 32 further obtains the detailed fault information from the SAS expander chip 35 through the smart port 34 in response to the detailed fault information obtaining command sent from the host PC 20, and sends the obtained detailed fault information back to the host PC 20 for debugging.

The maintenance personnel can determine a cause of the fault and correct the fault. After the fault is corrected, the maintenance personnel can use the host PC 20 to send a second control command to control the MCU 32 to enable the sideband port 33 to resume normal data transmission.

Therefore, without changing firmware of the SAS expander 30, the host PC 20 can access the SAS expander 30 through the SAS interface connector 31, and debug and analyze faults of the SAS expander 30 or the connected storage devices through the smart port 34 quickly.

It is to be understood that the foregoing disclosure may be embodied in other forms without departing from the scope thereof. Thus, the present examples and embodiments are to be considered in all respects as illustrative and not restrictive of the following claims.

What is claimed is:

1. A method for debugging fault of a Serial Attached SCSI (SAS) expander using a host personal computer (PC), the SAS expander comprising an exposed SAS interface connector coupled to a host PC, and a microcontroller unit (MCU), a smart port and an SAS expander chip arranged in the internal of the SAS expander, the method comprising:
receiving commands sent from the host PC using the SAS interface connector;
enabling the smart port in response to a first control command sent from the host PC;
reading status information from the SAS expander chip through the smart port in response to a status reading command sent from the host PC, and sending the read status information back to the host PC for analyzing; and
obtaining detailed fault information from the SAS expander chip through the smart port in response to a detailed fault information obtaining command sent from the host PC, and sending the obtained detailed fault information back to the host PC for debugging.

2. The method as described in claim 1, further comprising:
enabling a sideband port of the SAS expander to resume normal data transmission when the fault is corrected.

3. A Serial Attached SCSI (SAS) expander for connecting storage devices, the SAS expander comprising:
an exposed SAS interface connector coupled to a host personal computer (PC), the SAS interface connector configured to receive commands sent from the host PC;
a microcontroller unit (MCU), a smart port, and an SAS expander chip arranged in the internal of the SAS expander;
wherein, when a fault occurs in the SAS expander or one of the connected storage devices, the MCU enables the smart port in response to a first control command sent from the host PC, and reads status information from the SAS expander chip through the smart port in response to a status reading command sent from the host PC, and sends the read status information back to the host PC for analyzing; and
the MCU further obtains detailed fault information from the SAS expander chip through the smart port in response to a detailed fault information obtaining command sent from the host PC, and sends the obtained detailed fault information back to the host PC for debugging.

4. The SAS expander as described in claim 3, further comprising a sideband port arranged in the internal of the SAS expander, wherein the MCU enables the sideband port to resume normal data transmission when the fault is corrected.

5. The SAS expander as described in claim 3, wherein the SAS interface connector is selected from a group consisting of an SFF-8087 interface connector and an SFF-8088 interface connector.
